(19) United States
(12) Patent Application Publication
(10) Pub. No.: US 2011/0035990 A1
(43) Pub. Date: Feb. 17, 2011

(54) METHOD AND DEVICE FOR CONVERTING CARBONACEOUS RAW MATERIALS

(75) Inventors: Helmut Kammerloher, Freising (DE); Sven Johannssen, Regensburg (DE); Dragan Stevanovic, Sulzbach-Rosenberg (DE)

Correspondence Address: RISSMAN HENDRICKS & OLIVERIO, LLP, 100 Cambridge Street, Suite 2101, BOSTON, MA, 02114, US

(73) Assignee: KRONES AG, Neutraubling (DE)

(21) Appl. No.: 12/919,587

(22) PCT Filed: Feb. 28, 2009
(86) PCT No.: PCT/EP2009/001441

§ 371 Date: Oct. 29, 2010

(30) Foreign Application Priority Data
Feb. 28, 2008 (DE) 10 2008 014 297.2

(51) Int. Cl. C10L 1/10; B01J 10/00

(52) U.S. Cl. 44/311; 44/300; 422/187

(57) ABSTRACT

The invention relates to a method and a device (35) for converting carbonaceous raw materials and in particular biomass into fuels. In this method, firstly an allothermic gasification of the raw materials is performed in a gasifier (1) using heated water steam (3). After purification of the synthesis gas produced during the gasification and cooling of the synthesis gas, the synthesis gas is converted into a liquid fuel using a catalyzed chemical reaction. According to the invention, the heated water steam is used both as a gasification agent and also as a heat carrier for the gasification and has a temperature which is greater than 1000 DEG C.

The invention relates to a method and a device for converting carbonaceous raw materials into preferably liquid fuels. The invention will be described with reference to biomass, but it is pointed out that the method according to the invention and the device according to the invention can also be used for other carbonaceous products. The invention deals in particular with the production of BtL (biomass to liquid) fuels. This term denotes fuels which have been synthesised from biomass. In contrast to biodiesel, BtL fuel is generally obtained from solid biomass, such as for example fuelwood, straw, biowaste, meat and bone meal or cane, that is to say from cellulose or hemicellulose and not just from vegetable oil and oleaginous fruit.

The great advantages of this synthetic biofuel are its high yields in terms of biomass and area of up to 4000 l per hectare, without there being any competition for nutrients. In addition, this fuel has a high CO₂ reduction potential of more than 90% and its high quality is not subject to any use restrictions in present and foreseeable engine generations.

During the production of BtL fuels, usually in a first process step a gasification of biomass is carried out, followed by a subsequent generation of synthesis gas. This is synthesised at increased pressure and increased temperature to form the liquid fuel.

Fuels are understood to mean those substances which can be used as combustibles for internal combustion engines, such as in particular, but not exclusively, methanol, methane, benzene, diesel, paraffin, hydrogen and the like. Preferably, liquid fuels are produced under ambient conditions.

So-called autothermal methods are known from the prior art, in which air or oxygen is used as the gasification agent so that the necessary gasification energy is generated by the incomplete combustion of raw material. These methods are relatively simple, but have the disadvantage that there is a higher proportion of carbon dioxide in the product gas.

Some of the raw material introduced is used as a combustible and is therefore no longer available for producing the synthesis gas. Furthermore, when air is used as the gasification agent, the synthesis gas produced contains a high proportion of nitrogen, as a result of which the calorific value is in turn reduced.

Various gasifiers are known from the prior art, such as for example autothermal fixed bed gasifiers or also autothermal entrained flow gasifiers (cf. SunDiesel—made by Choren—Erfahrungen und neueste Entwicklungen, Matthias Rudloff in “Synthetische Biokraftstoffe”, Series “nachwachsende Rohstoffe” Vol. 25, Landwirtschaftsverlag GmbH, Munster 2005).

In so-called allothermal methods, the necessary gasification energy is supplied from outside, so that no additional quantity of CO₂ is produced in the gasifier itself and thus there is no loss of starting material as a combustible for energy generation. It is therefore also possible to use steam as the gasification agent (for the endothermic reaction). This leads to a higher concentration of hydrogen (H₂) in the synthesis gas. If the synthesis gas is used to generate the liquid fuels (for example in the context of a Fischer-Tropsch synthesis), this is advantageous.

Fluidised bed gasifiers according to the “Gassing” principle are known for example from the prior art. In this case, the necessary gasification energy is applied through the supply of hot sand (at a temperature of 950° C.). The pre-heating of this sand is once again brought about by the combustion of inserted raw material (in this case biomass). Here too, therefore, the valuable raw material is used as an energy source, which reduces the specific yield.

Furthermore, the gasification methods known from the prior art cannot be combined or can be combined only poorly with a so-called Fischer-Tropsch synthesis. Attempts have been made to combine the gasification methods known from the prior art with an installation for liquid fuel synthesis (such as e.g. a Fischer-Tropsch reactor), but this has resulted only in methods which have very poor or moderate degrees of efficacy for the production of liquid fuels. It has been found in expensive studies that the Fischer-Tropsch synthesis requires a specific synthesis gas composition (a ratio between H₂ and CO which is ≧2). Until now, an increase in this ratio has been able to be achieved by means of a so-called shift reaction: CO+H₂O [symbol] CO₂+H₂.

In the course of developing new fuels, in particular renewable fuels, various methods for the production thereof have recently been discovered.

DE 195 17 337 C2 discloses a biomass gasification method and an associated device. In this case, two electrodes supplied by a power source are provided in a reaction chamber, wherein an arc is generated between these electrodes.

DE 102 27 074 A1 describes a method for the gasification of biomass and an associated installation. In this case, the substances are burned in a combustion chamber which is separated in a gas-tight manner from a gasification reactor, and the thermal energy from the combustion chamber is introduced into the gasification reactor.

DE 198 36 428 C2 describes methods and devices for the gasification of biomass, in particular wood substances. In this case, a fixed bed gasification at temperatures up to 600° C. takes place in a first gasification stage and a fluidised bed gasification at temperatures between 800° C. and 1000° C. takes place in a subsequent second gasification stage.

DE 10 2005 006305 A1 discloses a method for producing combustible gases and synthesis gases with high-pressure steam generation. In this method, gasification processes in an entrained flow gasifier at temperatures below 1200° C. are used.

WO 2006/043112 discloses a method and an installation for treating biomass. In this case, temperatures of the steam between 800° C. and 950° C. are used for the gasification. The principle of fluidised bed gasification is used for the gasification. However, this method cannot be used for the gasification of raw materials with low ash melting points, such as for example many types of biomass, straw and the like. Furthermore, the steam temperatures in the range from 800° C. to 950° C. described therein are not sufficient to ensure a completely allothermal gasification. It is therefore necessary always to admix a certain quantity of air, which in turn leads to problems with carbon dioxide and nitrogen in the synthesis gas.

For heating the steam, a recuperative heat exchanger is used in the case of WO 2006/043112 A1. These heat exchangers have the disadvantage that they are very expensive and also the maintenance thereof is very complicated and costly. Furthermore, this method does not make use of the significant waste heat from the Fischer-Tropsch reactor that is produced during the synthesis process.

The object of the present invention is therefore to provide a method and a device for the gasification of carbonaceous raw materials, which allows a high efficiency and a high degree of efficacy. The intention is also to provide a method which feeds any resulting energy back to the process. More specifically, the intention is to provide a gasification method which allows an efficient conversion of the raw material and at the same time a particularly suitable ratio between hydrogen and carbon monoxide in the synthesis gas. In addition, the device according to the invention should also be suitable on the whole for smaller capacities and possible decentralised operation using different starting materials, in order to achieve good profitability. This is achieved by a method according to claim 1 and a device according to claim 12. Advantageous embodiments and further developments form the subject matter of the dependent claims.

In a method according to the invention for converting carbonaceous products and in particular biomass into liquid fuels, in a first step the carbonaceous raw materials are gasified in a gasifier, wherein heated steam is introduced into the gasifier. In a further step, the synthesis gas produced during the gasification is cleaned, and in a further step the temperature thereof is preferably changed. Preferably, the synthesis gas is cooled. Finally, the synthesis gas is converted into a liquid fuel by means of a catalysed chemical reaction, wherein a Fischer-Tropsch reactor is preferably used for this conversion. According to the invention, the gasification is a completely allothermal gasification and the heated steam serves both as the gasification agent and as the heat carrier for the gasification and has a temperature above 1000° C. An allothermal gasification is understood to mean that the heat is supplied from outside.

The method according to the invention is thus divided into at least 3 process steps, wherein firstly an allothermal gasification of the raw material (such as biomass and in particular straw) is carried out using steam which serves as the gasification agent and energy carrier. In the subsequent cleaning process, the gas is cleaned in particular of dust and tar and these substances are preferably then fed back into the gasification process. In the context of the preferred Fischer-Tropsch synthesis, synthesis gas is converted into liquid fuels.

In order to achieve a completely allothermal gasification according to the invention, it is necessary that the steam used has a temperature which is considerably above the mean gasification temperature. Temperatures of at least 1000° C. are therefore used, but preferably temperatures of more than 1200° C. and particularly preferably more than 1400° C.

By using the steam thus superheated as the gasification agent and energy carrier, a high excess of steam in the gasifier is achieved. This excess is preferably always above 2, particularly preferably above 3. Due to this excess of steam, on the one hand the formation of tar is reduced and on the other hand the tars produced have considerably shorter chains and are therefore more viscous than in the case of gasification without an excess of steam.

Furthermore, the ratio between hydrogen and carbon monoxide (H₂/CO) is at least equal to or even greater than 2, which is particularly advantageous for the subsequent Fischer-Tropsch synthesis. Finally, the high concentration of steam in the product gas also makes it possible to destroy residual tars in a thermal cracker, which is preferably arranged downstream. More specifically, these can be destroyed more easily in an atmosphere having a relatively high steam content.

It has until now not been possible to achieve such steam temperatures with the recuperative heat exchangers used in the prior art. However, use may be made of bulk generators as described for example in EP 0 620 909 B1 or DE 42 36 619 C2. The content of the disclosure of EP 0 620 909 B1 and DE 4 236 619 C2 is hereby fully incorporated by way of reference into the present disclosure. The use of such bulk regenerators leads to a more efficient device compared to the prior art.

In one preferred method, a synthesis gas having a particularly high H₂/CO ratio is produced, more specifically a ratio above 2.

In a further preferred method, a further gaseous medium is fed to the gasifier together with the steam. Said further gaseous medium is preferably oxygen or air, which together with the steam is heated to the temperature of the steam and are fed to the gasifier.

In a further preferred method, the highest temperature within the gasifier is always above the ash melting point. In this way, ash can be discharged in the liquid state.

Preferably, the gasifier is a counter-current fixed bed gasifier. In principle, use may be made of different types of gasifier according to the prior art. However, the particular advantage of a counter-current fixed bed gasifier lies in the fact that, inside this reactor, individual zones are formed in which different temperatures and thus different processes occur. The different temperatures are based on the fact that the respective processes are highly endothermic and the heat comes only from below. In this way, the very high steam temperatures are used in particularly advantageous manner. Since the highest steam temperatures prevail in the inlet zone of the gasification agent, it is possible always to produce the conditions for a liquid ash discharge.

This is particularly advantageous in the case of biomass gasification since in this case the ash melting points differ very greatly depending on the type of combustible and the soil properties.

In the prior art, it was not possible to convert different combustibles using one specific type of gasifier and thus to adapt to the market situation. However, due to the high temperatures, it is in principle possible according to the invention to configure the process in such a way that the ash produced is always discharged in liquid form. In cases where the ash melting point is particularly high, a predefined quantity of fluxing agent may preferably be added to the combustible. By virtue of the above-described simultaneous supply of oxygen or air, a further increase in temperature in the ash discharge zone can be achieved.

Preferably, the cleaning of the synthesis gas takes place by means of a cyclone and preferably by means of a multi-cyclone. In doing so, tars and dust produced can be separated out and can preferably be fed back into the gasifier.

Since the pyrolysis gases do not flow through any further hot zones, the tar content in the product gas is relatively high. This tar should not reach the reactor for the Fischer-Tropsch synthesis, since the tar is harmful to the catalysts used therein. Furthermore, the energy content of the tar is high and consequently has a negative effect on the process efficiency. The tar together with the arising dust is therefore preferably separated out immediately after the gasifier in a cyclone and particularly preferably in a multi-cyclone and is then injected into the high-temperature zone of the gasifier by means of a suitable pump. A cyclone is a centrifugal separator in which the substance to be separated is fed tangentially into a vertical, downward-tapering cylinder and is thus set in a rotational movement. By virtue of the centrifugal force acting on the dust particles, the latter are spun towards the outer wall, stopped by the latter and drop into the dust collecting space located therebelow.

Preferably, after the cleaning process, remaining tars are broken up into short-chain molecular structures. With particular preference, use is made here of a thermal cracker which breaks up the residual tars into short-chain molecular structures by virtue of very high temperatures, particularly advantageously between 800° C. and 1400° C., and preferably also by the supply of a small quantity of oxygen or air. During this so-called thermal cracking, the synthesis gas is thus brought to a very high temperature, as a result of which the long-chain molecular structures are broken up. At the same time, the residual quantity of dust is removed by virtue of this process.

Therefore, the cleaning in the cyclone is a first cleaning step and the cleaning in the cracker is a second cleaning step.

With particular preference, some of the greatly superheated gasification agent, that is to say the steam, is additionally supplied to the described cracker through a line. The gasification agent is thus used in addition to the thermal cracking.

In a further preferred method, the synthesis gas is cooled in a gas cooler and preferably then in a condenser, wherein excess steam is condensed out and can be used for heat recovery. The quantity of synthesis gas is thus reduced, and at the same time the proportions of the two most important components, namely CO and H₂, increase. In the condenser, the residual quantities of pollutants such as dust and tars are also washed out. If necessary, it is possible definitively to remove residual quantities of pollutants (which are in the ppm range), for example by using a washer comprising ZnO as catalyst.

In a further method, the synthesis gas is freed only of dust by means of a cyclone, so that the tars remain in the synthesis gas. This is ensured by means of electric heat tracing systems, with which the pipelines and the cyclone are kept at temperatures above the condensing temperature of the tars. The tars are removed together with the water from the synthesis gas in a condenser. This “tar water” forms a pumpable suspension which is vaporised, superheated and fed back to the gasification process.

In a CO₂ washer and in a heat exchanger, the synthesis gas is thus preferably prepared to the optimal composition and temperature for the subsequent Fischer-Tropsch synthesis. The quantity of CO₂ in the synthesis gas is reduced in the aforementioned CO₂ washer or in a PSA (Pressure Swing Absorption)/VSA (Vacuum Swing Absorption) system using molecular sieve technology, in order to ensure optimal conditions for the Fischer-Tropsch synthesis and an efficient energy use of the installation as a whole. The synthesis gas is preferably pre-heated in a gas pre-heater to an ideal temperature for the Fischer-Tropsch synthesis.

Preferably, the waste heat from at least one process following the gasification is used to produce saturated steam. In this case, it is possible for example to use the waste heat from the described gas cooler to pre-heat the water for the saturated steam production. Furthermore, the waste heat produced in the Fischer-Tropsch reactor itself can also be used to produce the saturated steam. The exothermic synthesis reaction in the Fischer-Tropsch reactor requires constant and uniform cooling. Preference is given to cooling with boiling water and subsequent saturated steam production. Besides the liquid fuel, the byproducts produced are a so-called off-gas, which consists of unreacted synthesis gas and of gaseous synthesis products, a water condensate and saturated steam due to the above-described cooling. In order to achieve a method with very high energy efficiency, particularly preferably all the waste heat energy flows or as many as possible thereof are fed into the gasification reactor. Thus, the energy from the gas cooler for the water pre-heating is used to produce superheated steam as the gasification agent, the waste heat from the cooling of the Fischer-Tropsch reactor is used to produce saturated steam, and the chemically bound energy of the off-gas is used to superheat steam by combustion in bulk reactors.

In this way, the resulting waste energy flows from the gas cooler and the Fischer-Tropsch reactor are fed back into the gasifier in the form of superheated steam, which allows an increase in efficiency compared to the prior art.

In a further preferred method, a predefined portion of resulting synthesis gas is fed to an off-gas produced during the synthesis. In this case, use is preferably made of a bypass line which is connected to the Fischer-Tropsch reactor.

In a further method, it is also possible to use an excess quantity of saturated steam for an external or internal heat consumer. It would also be possible to use the heat of the flue gas, which exits from the described bulk regenerators, for an external or internal heat consumer by means of a heat exchanger.

In a further advantageous method, a pressure generating device is provided which increases the pressure of the synthesis gas fed to the conversion. For example, a gas compressor may be provided which increases the synthesis gas after the condenser to the necessary pressure for the Fischer-Tropsch reactor. The entire device may also advantageously be at a pressure which is advantageous for the synthesis process in the Fischer-Tropsch reactor. In this way, the efficiency of the entire process can be increased.

In a further advantageous method, saturated steam is superheated by means of a suitable internal or external heat source and is expanded in a steam turbine before being fed to the bulk regenerators.

More specifically, the entire installation, with the exception of the Fischer-Tropsch reactor and the steam-conveying lines, may be unpressurised and the necessary energy for the synthesis gas compression can be drawn from the steam turbine. In this way, the investment costs can be lowered while maintaining the same degree of efficacy.

In a further advantageous method, condensate produced during the conversion is used as an additional fluid to the condensate from the condenser to produce the saturated steam. In this way, a closed water circuit is provided overall.

In a further method according to the invention, the heated steam is used both as the gasification agent and also as the heat carrier for the gasification and has a temperature above 1000° C. In addition, a further gaseous medium is fed to the gasifier separately from the heated steam. Advantageously, the further gaseous medium has a temperature below 600° C., preferably below 400° C. and particularly preferably below 300° C. It would also be possible to provide room temperature. In a further advantageous method, the gasification is an allothermal gasification. By virtue of the separate supply of air and steam, the situation can be achieved whereby the air, which preferably does not contribute to the actual gasification process, need not be heated, so that overall the energy efficiency of the method can be increased.

In this further method according to the invention, slightly heated air or oxygen is thus introduced into the reactor separately from the heated steam. This air/oxygen addition is used to adjust the gas composition and not to provide energy, since this takes place by virtue of the superheated steam (allothermal gasification). By adding air/oxygen, it is possible to influence the proportions of hydrogen (H₂) and carbon monoxide (CO) in the product gas. For the Fischer-Tropsch synthesis, it is advantageous if an H₂/CO ratio of ˜2.15 to 1 is set. Furthermore, the addition of air/oxygen has an effect on the gasification temperature and the proportions of CO₂ and CH₄ in the product gas.

The present invention also relates to a device for converting carbonaceous raw materials and in particular biomass into liquid fuels, wherein this device comprises a gasifier, in which the carbonaceous raw materials are gasified by means of heated steam, at least one cleaning unit which is used to clean the synthesis gas produced during the gasification, at least one temperature-changing unit for changing the temperature of the resulting synthesis gas, and a conversion unit for converting the synthesis gas into liquid fuel. According to the invention, the device has at least one heating device which heats the steam to a temperature above 1000° C. The temperature-changing unit is preferably a cooling unit.

Preferably, the cleaning unit is a cyclone and particularly preferably a multi-cyclone.

In a further advantageous embodiment, the device has a further cleaning unit which deals with residual tars. This is in particular, but not exclusively, the cracker described above.

In a further advantageous embodiment, two cooling devices are provided in the form of a gas cooler and a condenser arranged downstream of this gas cooler.

In a further advantageous embodiment, the device has a conveying device which is arranged between the cleaning unit and the gasifier and conveys back into the gasifier a product, in particular tar, obtained during the cleaning process.

In a further advantageous embodiment, at least two heating devices are provided, wherein at least two of these heating devices are operated in phase opposition. In this way, a continuous heating process for the gasification agent can be achieved.

The present invention also relates to a method of the type described above, wherein a device of the type described above is used to carry out the method.

Further advantages and embodiments will emerge from the appended drawings.

In the drawings:

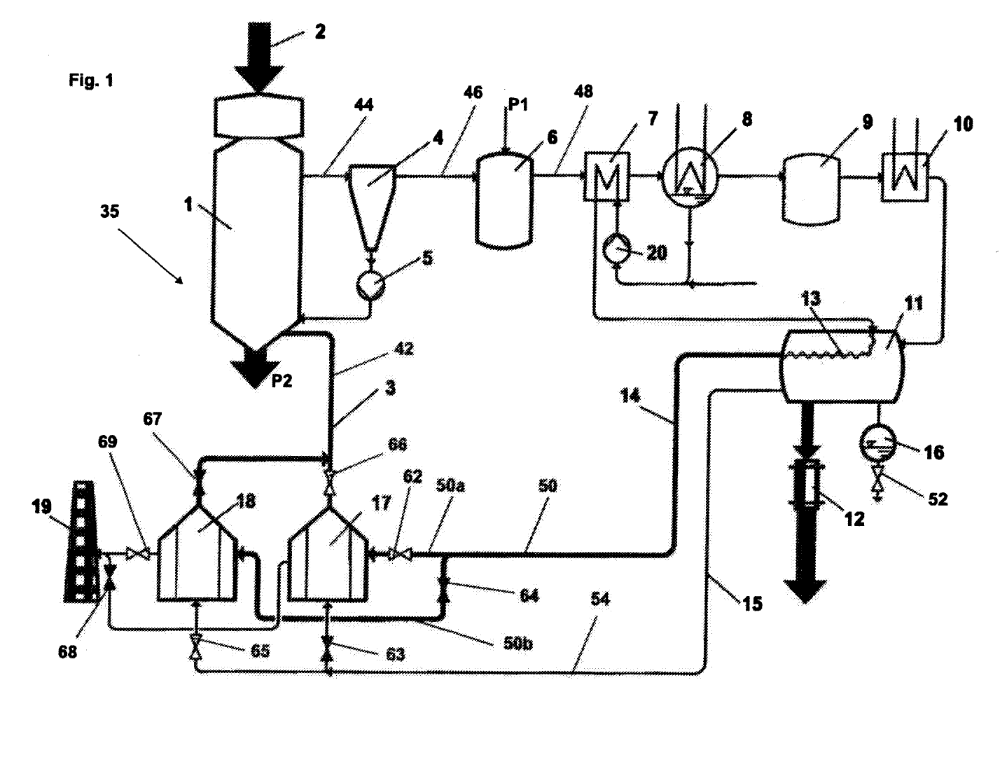

FIG. 1 shows a schematic view of a device according to the invention;

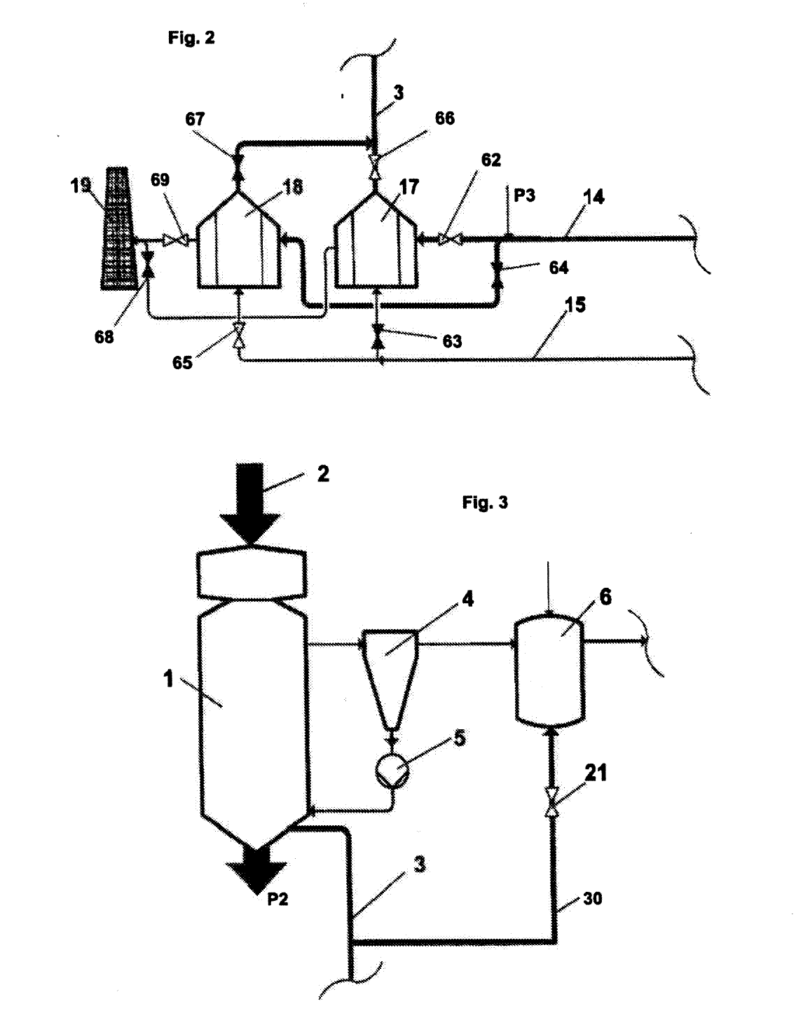

FIG. 2 shows a detail view of the device of FIG. 1 to illustrate the heating of the steam;

FIG. 3 shows a further detail view of the device of FIG. 1 to illustrate the cleaning of the synthesis gas;

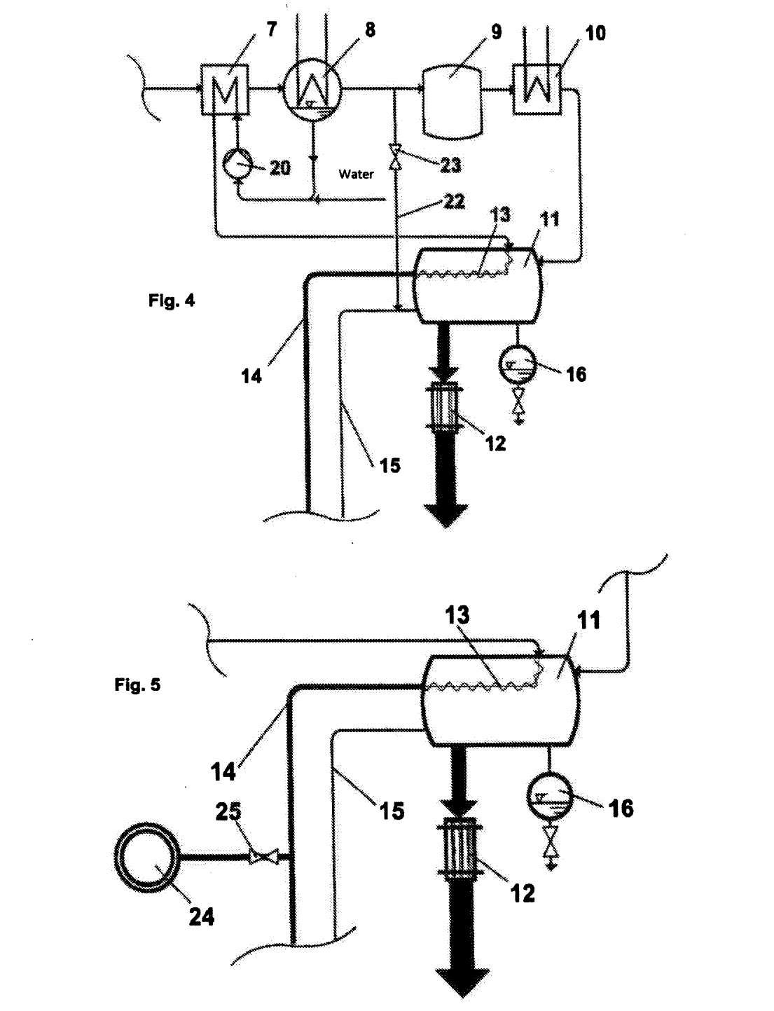

FIG. 4 shows a further detail view of the device of FIG. 1 in a further embodiment;

FIG. 5 shows a further detail view of the device of FIG. 1 in a further embodiment;

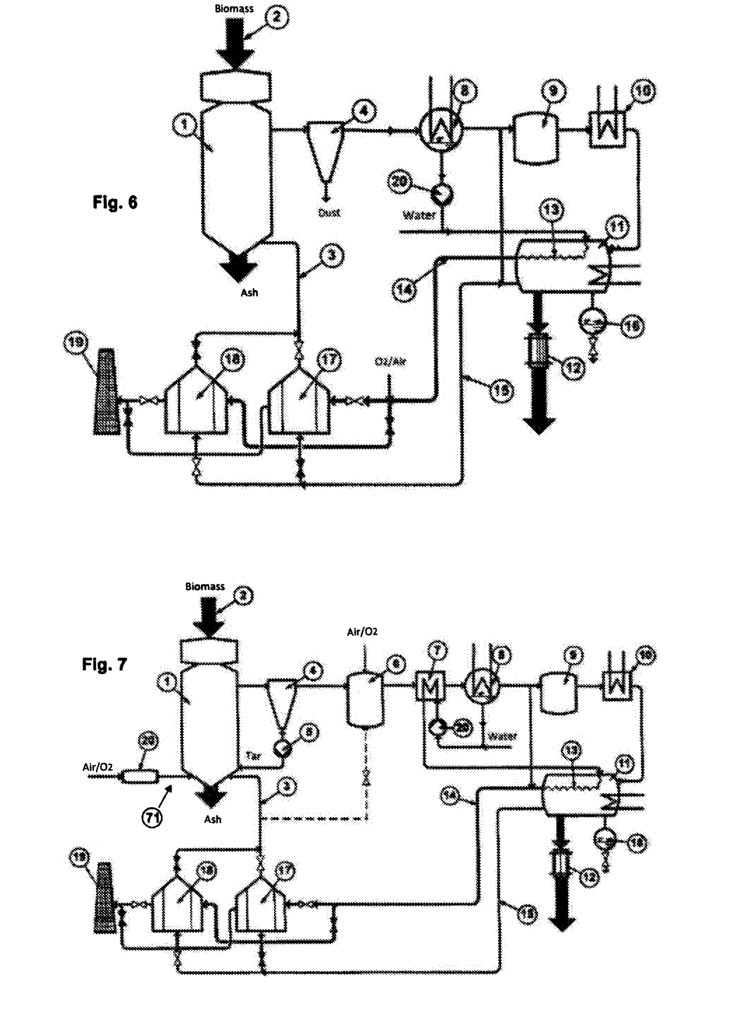

FIG. 6 shows an alternative flow diagram with a condensing of the tars and water out of the synthesis gas and with the regenerators being used as a steam superheater and cracker for the tars arising during the gasification; and

FIG. 7 shows an alternative flow diagram with an air/oxygen addition, after the superheating of the steam.

FIG. 1 shows a schematic view of a device 35 according to the invention for converting carbonaceous raw materials into synthesis gas and for subsequent liquid fuel synthesis. Here, reference 1 denotes a counter-current fixed bed reactor. The raw material 2 is introduced into the reactor 1 from above and the gasification agent 3 is introduced from below through a supply line 42. In this way, the gasification agent 3 and the synthesis gas produced flow through the reaction chamber in the opposite direction to the flow of combustibles. The ash produced in the gasifier 1 is discharged in the downward direction, that is to say in the direction of the arrow P2.

Starting from the reactor 1, the synthesis gas passes through a line 44 into a cyclone or preferably a multi-cyclone. In this cyclone 4, most of the tar and of the dust produced are separated out and are injected back into the high-temperature zone of the gasifier 1 by means of a pump 5. The synthesis gas pre-cleaned in this way, which contains residual tar together with residual quantities of dust, passes through a further line 46 into a thermal cracker 6. In this thermal cracker, the residual tar together with the dust is destroyed at maximum temperatures between 800° C. and 1400° C. In order to achieve the necessary temperature, a predefined quantity of oxygen and/or air may optionally be injected directly into the high-temperature zone and in this way a partial oxidation of the tars can be achieved (see arrow P1).

After the thermal cracker, the synthesis gas passes through a line 48 into a gas cooler 7. In this gas cooler, the synthesis gas is cooled so that excess steam is condensed out in the downstream condenser 8. Optionally, the quantity of CO₂ in the synthesis gas may be reduced by means of a CO₂ washer 9 or a PSA/VSA system using molecular sieve technology. In addition, residual quantities of pollutants (which are in the ppm range) may be completely removed, for example by means of a washer (not shown) using ZnO. Reference 10 denotes a gas pre-heater, in which the synthesis gas is pre-heated to a suitable temperature for the Fischer-Tropsch synthesis which takes place subsequently.

Reference 11 denotes a Fischer-Tropsch reactor, in which the synthetic liquid fuel 12, e.g. BtL in the case of biomass gasification, is produced from the synthesis gas under suitable thermodynamic conditions, that is to say at an appropriate pressure and temperature. As byproducts of this synthesis, saturated steam 14 is produced by a cooling 13 of the reactor and also an off-gas 15 is produced which consists of unreacted synthesis gas and gaseous synthesis products. A water condensate 16 is also obtained. This water condensate 16 can be drained off via a valve 52.

The saturated steam 14 then passes through a connecting line 50, which is split into two sub-lines 50a and 50b, into two bulk regenerators 17 and 18. In these bulk regenerators, the steam is superheated to the necessary temperature. In the device shown in FIG. 1, two bulk regenerators 17, 18 are provided which allow continuous operation of the installation. While the steam is being superheated in the bulk regenerator 17, the bulk regenerator 18 is in a heat-up phase, that is to say it is being charged with thermal energy in particular by the combustion of off-gas 15 which is supplied to it from the Fischer-Tropsch reactor 11 through a connecting line 54. A plurality of valves 62 to 69 are used to control the two bulk regenerators. Here, the valves 62, 63, 66 and 68 are assigned to the bulk regenerator 17 and the valves 64, 65, 67 and 69 are assigned to the bulk regenerator 18.

The respectively produced combustion gases leave the installation through a chimney 19. By periodically switching the illustrated valves 62-69, the two bulk regenerators 17 and 18 can be operated alternately. It is also possible to produce the necessary steam from the condensate coming from the condenser 8. Depending on the water content of the raw material 2, it is possible to use additional quantities of water, for example the condensate 16 from the Fischer-Tropsch reactor. Since the necessary quantity of water is conveyed through the gas cooler 7 by means of the pump 20, a pre-heating thus also takes place.

In the cooler 13 of the Fischer-Tropsch generator 11, saturated steam 14 is likewise produced, which is once again superheated in the bulk regenerators 17 and 18, wherein in this case the chemical energy from the off-gas 15 can be used. In this way, the entire waste energy produced during the process is supplied to the superheated steam 3, and thus the steam can be heated in a particularly advantageous manner.

Instead of the two bulk regenerators 17, 18 shown in FIG. 1, three or even more bulk regenerators may also be used in order to achieve particularly consistent operation.

FIG. 2 shows a detail view of a further embodiment of the device shown in FIG. 1. Here, oxygen and/or air is additionally introduced along the arrow P3. In this way, the oxygen can be superheated together with the steam to a very high temperature in the bulk regenerators 17 and 18, which are also known as pebble heaters. In this case it is possible, even with a relatively small quantity of less than 10% by volume of oxygen or air in the highly superheated gasification agent, to increase considerably the temperature in the ash melting zone so as in this way to obtain a low viscosity ash. This measure, that is to say the supply of air or oxygen, can also further increase the utilisation of carbon and can positively influence the tar formation by increasing the raw gas temperature.

FIG. 3 shows a further preferred embodiment of a device according to the invention. Here, a line 30 is additionally provided, through which gasification agent can be injected into the cracker 6. This measure is particularly effective when the required temperature in the cracker 6 is considerably below the gasification agent temperature and if the gasification agents contain a certain proportion of oxygen or air (cf. FIG. 2). The quantity to be injected can be controlled by means of a hot gas control valve 21.

FIG. 4 shows a further detail view of a preferred embodiment. In this case, a further line 22 and also a further control valve 23 are provided. If the quantity of off-gas 15 for heating the gasification agent 3 in the bulk regenerators 17 and 18 is not sufficient, an additional quantity of synthesis gas can be supplied via this line, for example after the condenser 8, through the bypass line 22.

FIG. 5 shows a further detail view of a preferred embodiment. If the quantity of saturated steam 14 from the cooling of the Fischer-Tropsch reactor 11 is greater than the required quantity of steam for the gasification reactor 1, the excess quantity of saturated steam can be conducted to an external or internal heat consumer 24 (for example a drying installation). In this way, the process efficiency can be further increased. The excess quantity of saturated steam is also adjusted here by a control valve 25.

FIG. 6 shows an alternative to the tar cleaning and elimination from the product gas. In the cyclone 4, the product gas is freed of dust. In a condenser 8, the water and the tars are condensed out at a temperature of 50° C. In order to prevent the tars from condensing out prematurely, the pipelines between the gasifier and the condenser are heated to more than 200° C., particularly advantageously more than 300° C. A tar/water mixture forms. The tar water is optionally mixed with water and conveyed by means of the pump 20 and is brought to an operating pressure of >1 bar, advantageously to 10 bar and particularly advantageously to 30 bar. This is then vaporised by the resulting heat of the Fischer-Tropsch synthesis 13 and is fed via the pipeline 14 to the regenerators 17 and 18. In the regenerators, the steam is superheated as already described and the tars are cracked. Via the pipeline 3, the steam and the gases of the cracked tar pass into the gasifier. The advantage of this method is to be seen in the fact that there is no need for system parts that would otherwise be necessary.

FIG. 7 shows an alternative for the gasification process, in which steam, additionally slightly heated air 20 or pure oxygen is added to the actual gasification agent in the reactor. This takes place in order to adjust the gas composition of the product gas. In this case, this air is fed to the gasifier via a further supply line 71.

All of the features disclosed in the application documents are claimed as essential to the invention in so far as they are novel individually or in combination with respect to the prior art.

1-26. (canceled)

27. Method for converting carbonaceous raw materials and in particular biomass into fuels, comprising the steps:
gasifying the carbonaceous raw materials in a gasifier, heated steam being introduced into the gasifier used for the gasification;
cleaning synthesis gas produced during the gasification;
changing the temperature of the synthesis gas; and
converting the synthesis gas into a liquid fuel by means of a catalysed chemical reaction,
wherein the gasification is an allothermal gasification and the heated steam is used both as a gasification agent and as a heat carrier for the gasification and has a temperature above 1000° C.

28. Method according to claim 27, further comprising feeding a further gaseous medium to the gasifier together with the steam.

29. Method according to claim 27, wherein the gasifier is a counter-current fixed bed gasifier.

30. Method according to claim 27, wherein the operating temperature in the gasifier is always above the ash melting point.

31. Method according to claim 27, wherein the cleaning of the synthesis gas takes place by means of a cyclone.

32. Method according to claim 27, further comprising, after the cleaning process, breaking up the molecular structures of remaining tars into short-chain molecular structures.

33. Method according to claim 27, further comprising using the waste heat from at least one process following the gasification to produce saturated steam.

34. Method according to claim 27, further comprising feeding a predefined portion of resulting synthesis gas to an off-gas produced during the synthesis.

35. Method according to claim 27, further comprising providing a pressure generating device which increases the pressure of the synthesis gas fed to the conversion.

36. Method according to claim 27, further comprising:
superheating saturated steam by means of a heat source; and
expanding said steam in a steam turbine before feeding said steam to bulk regenerators.

37. Method according to claim 27, further comprising using condensate produced during the conversion as an additional fluid to the condensate from the condenser to produce the saturated steam.

38. Method according to claim 27, further comprising substantially separating out the resulting tars and dust together in a cyclone.

39. Method according to claim 38, further comprising heating at least one pipeline and the cyclone.

40. Method according to claim 39, further comprising using the condenser to separate out water and tar.

41. Method according to claim 40, further comprising using the high temperatures of the bulk regenerators, in addition to the steam superheating, for cracking the tars arising from the gasification.

42. Method for converting carbonaceous raw materials and in particular biomass into fuels, comprising the steps:
gasifying the carbonaceous raw materials in a gasifier, heated steam being introduced into the gasifier used for the gasification;
cleaning synthesis gas produced during the gasification;
changing the temperature of the synthesis gas; and
converting the synthesis gas into a liquid fuel by means of a catalysed chemical reaction,
wherein the heated steam is used both as a gasification agent and as a heat carrier for the gasification and has a temperature above 1000° C., and a further gaseous medium is fed to the gasifier separately from the heated steam.

43. Method according to claim 42, wherein the further gaseous medium has a temperature below 600° C. and preferably below 400° C.

44. Method according to claim 42, wherein the gasification is an allothermal gasification.

45. A device for converting carbonaceous raw materials and in particular biomass into liquid fuels, comprising:
at least one heating device which heats steam to a temperature above 1000° C.;
a gasifier, in which the carbonaceous raw materials are gasified by means of said heated steam;
at least one cleaning unit for cleaning the synthesis gas produced during the gasification;
at least one temperature-changing unit for changing the temperature of the resulting synthesis gas; and
a conversion unit for converting the synthesis gas into a liquid fuel.

46. A device according to claim 45, wherein the cleaning unit is a cyclone.

47. A device according to claim 45, further comprising a cleaning unit which deals with residual tars.

48. A device according to claim 45, further comprising two temperature-changing devices in the form of a gas cooler and a condenser arranged downstream of said gas cooler.

49. A device according to claim 45, further comprising a conveying device which is arranged between the cleaning unit and the gasifier and conveys into the gasifier a product obtained during the cleaning process.

50. A device according to claim 45, further comprising at least two heating devices, wherein at least two of these heating devices are operated in phase opposition.

51. A device according to claim 45, further comprising a supply line for supplying a gaseous medium to the gasifier separately from the steam.

52. Method according to claim 5, wherein the cleaning of the synthesis gas takes place by means of a multi-cyclone.

53. Method according to claim 12, wherein the cleaning of the synthesis gas takes place by means of a multi-cyclone.

54. Method according to claim 12, further comprising burning said resulting tars and dust in bulk regenerators.

55. A device according to claim 45, wherein the cleaning unit is a multi-cyclone.
